(19) United States
(12) Patent Application Publication
(10) Pub. No.: US 2010/0289832 A1
(43) Pub. Date: Nov. 18, 2010

(54) Display apparatus

(75) Inventors: Tetsuro Yamamoto, Kanagawa (JP); Katsuhide Uchino, Kanagawa (JP); Hiroshi Sagawa, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/662,351

(22) Filed: Apr. 13, 2010

(30) Foreign Application Priority Data
May 12, 2009 (JP) 2009-115193

(51) Int. Cl. G09G 5/10

(52) U.S. Cl. 345/690; 345/77

(57) ABSTRACT

A display apparatus includes: a pixel array including a plurality of pixel circuits disposed in a matrix and each including a light emitting element, a driving transistor for supplying current in response to a signal value applied between a gate and a source thereof to the light emitting element when a driving voltage is applied between a drain and the source thereof, and a holding capacitor connected between the gate and the source of the driving transistor for holding the input signal value, the driving transistor having a multi-gate structure wherein two or more transistors formed using an oxide semiconductor material are connected in series; and a light emission driving section.

### BACKGROUND OF THE INVENTION

1. Field of the Invention

This invention relates to a display apparatus having a pixel array including a plurality of pixel circuits disposed in a matrix and another display apparatus which uses an organic electroluminescence element, that is, an organic EL element.

Japanese Patent Laid-Open Nos. 2003-255856 and 2003-271095 are known as related art documents to the inventor.

2. Description of the Related Art

In a display apparatus of the active matrix type wherein an organic electroluminescence (EL) light emitting element is used in a pixel, current to flow through a light emitting element in each pixel circuit is controlled by an active element, usually a thin film transistor (TFT), provided in the pixel circuit. In particular, since an organic EL element is a current light emitting element, a gradation of emitted light is obtained by controlling the amount of current to flow through the EL element.

An example of a related art pixel circuit which uses an organic EL element is shown in FIG. 9A.

It is to be noted that, although only one pixel circuit is shown in FIG. 9A, in an actual display apparatus, m×n such pixel circuits as shown in FIG. 9A are disposed in a matrix, that is, an m×n matrix, such that each pixel circuit is selected and driven by a horizontal selector 101 and a write scanner 102.

Referring to FIG. 9A, the pixel circuit shown includes a sampling transistor Ts in the form of an re-channel TFT, a holding capacitor Cs, a driving transistor Td in the form of a p-channel TFT, and an organic EL element 1. The pixel circuit is disposed at a crossing point between a signal line DTL and a write controlling line WSL. The signal line DTL is connected to a terminal of the sampling transistor Ts and the write controlling line WSL is connected to the gate of the sampling transistor Ts.

The driving transistor Td and the organic EL element 1 are connected in series between a power supply potential Vcc and the ground potential. Further, the sampling transistor Ts and the holding capacitor Cs are connected to the gate of the driving transistor Td. The gate-source voltage of the driving transistor Td is represented by Vgs.

In the pixel circuit, if the write controlling line WSL is placed into a selected state and a signal value corresponding to a luminance signal is applied to the signal line DTL, then the sampling transistor Ts is rendered conducting and the signal value is written into the holding capacitor Cs. The signal potential written in the holding capacitor Cs becomes a gate potential of the driving transistor Td.

If the write controlling line WSL is placed into a non-selected state, then the signal line DTL and the driving transistor Td are electrically disconnected from each other. However, the gate potential of the driving transistor Td is kept stably by the holding capacitor Cs. Then, driving current Ids flows through the driving transistor Td and the organic EL element 1 from the power supply potential Vcc toward the ground potential.

At this time, the current Ids exhibits a value corresponding to the gate-source voltage Vgs of the driving transistor Td, and the organic EL element 1 emits light with a luminance in accordance with the current value.

In particular, in the present pixel circuit, a signal value potential from the signal line DTL is written into the holding capacitor Cs to vary the gate application voltage of the driving transistor Td thereby to control the value of current to flow to the organic EL element 1 to obtain a gradation of color development.

Since the driving transistor Td in the form of a p-channel TFT is connected at the source thereof to the power supply potential Vcc and is designed in such a manner as to normally operate in a saturation region, the driving transistor Td serves as a constant current source having a value given by the following expression (1):

Ids=(½)·μ·(W/L)·Cox·(Vgs−Vth)² (1)

where Ids is current flowing between the drain and the source of a transistor which operates in a saturation region, μ the mobility, W the channel width, L the channel length, Cox the gate capacitance, and Vth the threshold voltage of the driving transistor Td.

As apparently recognized from the expression (1) above, in the saturation region, the drain current Ids of the transistor is controlled by the gate-source voltage Vgs. Since the gate-source voltage Vgs is kept fixed, the driving transistor Td operates as a constant current source and can drive the organic EL element 1 to emit light with a fixed luminance.

FIG. 9B illustrates a time-dependent variation of the current-voltage (I-V) characteristic of an organic EL element. A curve shown by a solid line indicates a characteristic in an initial state, and another curve shown by a broken line indicates the characteristic after time-dependent variation. Generally, the I-V characteristic of an organic EL element deteriorates as time passes as seen from FIG. 9B. In the pixel circuit of FIG. 9A, the drain voltage of the driving transistor Td varies together with time-dependent variation of the organic EL element 1. However, since the gate-source voltage Vgs in the pixel circuit of FIG. 9A is fixed, a fixed amount of current flows to the organic EL element 1 and the emitted light luminance does not vary. In short, stabilized gradation control can be carried out.

On the other hand, if the driving transistor Td is formed from an n-channel TFT, then it becomes possible to use a related art amorphous silicon (a-Si) process in TFT fabrication. This makes it possible to reduce the cost of a TFT substrate.

FIG. 10A shows a configuration wherein the driving transistor Td in the form of a p-channel TFT of the pixel circuit shown in FIG. 9A is replaced with an n-channel TFT.

Referring to FIG. 10A, in the pixel circuit shown, the driving transistor Td is connected at the drain side thereof to the power supply potential Vcc and at the source thereof to the anode of the organic EL element 1 thereby to form a source follower circuit.

However, where the driving transistor Td is replaced with an n-channel TFT in this manner, since it is connected at the source thereof to the organic EL element 1, the gate-source voltage Vgs varies together with such time-dependent variation of the organic EL element 1 as illustrated in FIG. 9B. Consequently, the amount of current flowing to the organic EL element 1 varies, and as a result, the emitted light luminance of the organic EL element 1 varies. In other words, appropriate gradation control cannot be carried out any more.

Further, in an organic EL display apparatus of the active matrix type, in addition to time-dependent variation of the organic EL element 1, also the threshold voltage of an n-channel TFT of a component of the pixel circuit varies as time passes. As apparent from the expression (1) given hereinabove, if the threshold voltage Vth of the driving transistor Td varies, then the drain current Ids of the driving transistor Td varies.

Consequently, the amount of current flowing to the EL element varies, and as a result, the emitted light luminance of the EL element varies. Further, since the threshold value and the mobility of the driving transistor Td differ among different pixels, a dispersion occurs in the value of current in accordance with the expression (1) and also the emitted light luminance differs among different pixels.

As a circuit which prevents an influence of time-dependent variation of an organic EL element and a characteristic dispersion of a driving transistor upon the emitted light luminance and besides includes a comparatively small number of elements, a circuit shown in FIG. 10B has been proposed.

Referring to FIG. 10B, a holding capacitor Cs is connected between the gate and the source of a driving transistor Td. Further, a drive scanner 103 applies a driving voltage Vcc and an initial voltage Vss alternately to a power supply controlling line DSL. In other words, the driving voltage Vcc and the initial voltage Vss are applied at predetermined timings to the driving transistor Td.

In this instance, the drive scanner 103 first applies the initial voltage Vss to the power supply controlling line DSL to initialize the source potential of the driving transistor Td. Then, within a period within which the potential as a reference value is applied to the signal line DTL by the horizontal selector 101, a write scanner 102 renders the sampling transistor Ts conducting to fix the gate potential of the driving transistor Td to the reference value. In this state, the drive scanner 103 applies the driving voltage Vcc to the driving transistor Td to cause the holding capacitor Cs to hold the threshold voltage Vth of the driving transistor Td. In short, a threshold value correction operation is carried out.

Thereafter, within a period within which the signal value potential is applied from the horizontal selector 101 to the signal line DTL, the sampling transistor Ts is rendered conducting under the control of the write scanner to write the signal value into the holding capacitor Cs. At this time, also mobility correction of the driving transistor Td is carried out.

Thereafter, current in accordance with the signal value written in the holding capacitor Cs flows to the organic EL element 1 to carry out emission of light with a luminance in accordance with the signal value.

By the operation described, an influence of a dispersion in threshold value or mobility of the driving transistor Td is canceled. Further, since the gate-source voltage of the driving transistor Td is kept at a fixed value, the current flowing to the organic EL element 1 does not vary. Therefore, even if the I-V characteristic of the organic EL element 1 deteriorates, the current Ids normally continues to flow and the emitted light luminance does not vary.

### SUMMARY OF THE INVENTION

Here, use of an oxide semiconductor in a driving transistor is studied.

Generally, an oxide semiconductor transistor signifies a transistor in which an oxide such as ZnO or IGZO is used as a material for a channel of the transistor. It is to be noted that generally an oxide semiconductor TFT is characterized in that it is low in threshold voltage (in the negative) and high in mobility (approximately 10) in comparison with an amorphous silicon TFT.

In such a transistor wherein an oxide is used as a channel material as described above, the oxygen in the channel plays a very important role. In particular, where the oxygen concentration in the channel is low, there is a problem that a normal transistor characteristic is lost in that the off current increases as indicated by a broken line in FIG. 11.

In order to take a countermeasure against such a problem as just described, it is desirable to carry out oxygen annealing when a transistor is fabricated so that oxygen is always supplied to the channel thereby to prevent oxygen from being desorbed from the channel.

However, such oxygen desorption from the channel not only occurs when a transistor is fabricated but also occurs continuously after the transistor is fabricated.

An example of a structure of a transistor is shown in FIGS. 12A and 12B. FIG. 12A is a schematic view showing the transistor from above and FIG. 12B is a schematic view of a cross sectional structure of the transistor. Referring to FIGS. 12A and 12B, the transistor shown includes gate metal 91, a gate insulating film 92, channel material 93, a stopper insulating film 94, and source metal 95. It is to be noted that the channel width is represented by W and the channel length is represented by L.

If an oxide is used for the channel material 93 in the structure described, oxygen desorption occurs almost in a region indicated by slanting lines in FIG. 12A. In particular, oxygen desorption occurs in a region in which the stopper insulating film 94 and the channel material 93 overlap with each other while the source metal 95 does not overlap with them.

Basically, an oxide semiconductor dislikes desorption of oxygen from the channel after the channel material 93 is fabricated, and the stopper insulating film 94 is produced at a comparatively low temperature.

Therefore, the film quality of the stopper insulating film 94 is poor, and it is difficult for the stopper insulating film 94 to prevent desorption of oxygen from the channel.

Therefore, if the amount of oxygen which desorbs from the channel increases, then the period within which the transistor operates regularly becomes short and the lifetime of the display apparatus becomes short.

Further, since an oxide semiconductor has a high mobility as described hereinabove, when required current is supplied to a pixel, the channel width W of the transistor can be reduced in comparison with that of an amorphous silicon transistor.

However, since the channel width W cannot be made smaller than a certain fixed value depending upon a wiring rule of the process, in order to cope with this, the channel length L must be increased.

If the channel length L is increased, then this increases the region within which oxygen desorbs as described above. Therefore, although it becomes easy to supply oxygen upon fabrication of a transistor, after fabrication of the transistor, a characteristic thereof varies by an increased amount if the panel is stored at a high temperature or in a like case. Therefore, such a drawback in picture quality as unevenness or roughness occurs.

Therefore, it is desirable to provide a display apparatus wherein, where an oxide semiconductor is used, desorption of oxygen from the channel can be reduced.

Also it is desirable to provide a display apparatus wherein picture operation including threshold value correction or mobility correction can be carried out appropriately in a pixel circuit fabricated using an oxide semiconductor.

According to an embodiment of the present invention, there is provided a display apparatus including: a pixel array including a plurality of pixel circuits disposed in a matrix and each including a light emitting element, a driving transistor for supplying current in response to a signal value applied between a gate and a source thereof to the light emitting element when a driving voltage is applied between a drain and the source thereof, and a holding capacitor connected between the gate and the source of the driving transistor for holding the input signal value, the driving transistor having a multi-gate structure wherein two or more transistors formed using an oxide semiconductor material are connected in series; and a light emission driving section configured to apply the signal value to the holding capacitor of each of the pixel circuits of the pixel array so that the light emitting element of the pixel circuit emits light of a gradation corresponding to the signal value.

Each of the pixel circuits may include a sampling transistor for applying the signal value supplied from the light emission driving section to the holding capacitor, also the sampling transistor having a multi-gate structure wherein two or more transistors formed using an oxide semiconductor material are connected in series.

In this instance, the light emission driving section may include a signal selector for supplying a potential as the signal value and a reference value to each of signal lines disposed so as to extend in the direction of a column on the pixel array, a write scanner for driving each of writing control lines disposed so as to extend in the direction of a row on the pixel array to introduce the potential of the corresponding signal line into the pixel circuits, and a driving control scanner for applying a driving voltage to the driving transistor of the pixel circuits using each of power supply control lines disposed so as to extend in a row on the pixel array, the sampling transistor being connected at a gate thereof to the writing control line, at one of a source and a drain thereof to the signal line and at the other of the source and the drain thereof to the gate of the driving transistor.

Further, each of the pixel circuits may carry out, as a light emission operation of one cycle: a threshold value correction operation of the driving transistor of the multi-gate structure by rendering the sampling transistor conducting under the control of the write scanner, within a period within which the potential as the reference value is applied to the signal line by the signal selector, to fix the gate potential of the driving transistor to the reference value and applying, in this state, the driving voltage to the driving transistor from the driving control scanner; writing of the signal value into the holding capacitor and a mobility correction operation of the driving transistor of the multi-gate structure within another period within which the potential as the signal value is applied to the signal line from the selector by rendering the sampling transistor under the control of the write scanner; and emission of light from the light emitting element with a luminance in accordance with the signal value by supplying, after the writing of the signal value and the mobility correction, the current in accordance with the signal value written in the holding capacitor from the driving transistor to the light emitting element.

The light emitting element may be an organic electroluminescence light emitting element.

According to another embodiment of the present invention, there is provided a display apparatus including a pixel array including a plurality of pixel circuits disposed in a matrix and each including an organic electroluminescence light emitting element, a plurality of transistors including a driving transistor for supplying current in accordance with a signal value provided between a gate and a source thereof to the organic electroluminescence light emitting element when a driving voltage is applied between a drain and the source thereof, and a holding capacitor connected between the gate and the source of the driving transistor for holding the signal value inputted thereto, all of the plural transistors having a multi-gate structure wherein two or more transistors formed using an oxide semiconductor material are connected in series to each other, and a light emission driving section configured to apply the signal value to the holding capacitor of each of the pixel circuits of the pixel array so that the light emitting element of the pixel circuit emits light of a gradation corresponding to the signal value.

In both of the display apparatus, each of the pixel circuits adopts a transistor formed using an oxide semiconductor material. Further, in each pixel circuit which includes a driving transistor, a sampling transistor for signal writing, a holding capacitor, an organic EL element and so forth, at least the driving transistor is formed with a multi-gate structure wherein two or more transistors are connected in series. For example, the driving transistor is formed with a double gate structure wherein two transistors are connected in series to each other. Or both of the driving transistor and the sampling transistor or all transistors in the pixel circuit are formed with the multi-gate structure such as, for example, the double gate structure.

Since the multi-gate structure is applied to the oxide semiconductor transistors, where the transistors are provided with a current supplying capacity with a channel width and a channel length equal to those in the single gate structure, the region in which oxygen desorption occurs can be decreased and oxygen desorption from a channel material of the transistor can be reduced.

Further, inappropriate operation upon threshold value correction and mobility correction which may possibly occur in the signal gate structure of an oxide semiconductor transistor can be eliminated.

With the display apparatus, since each pixel circuit adopts a transistor formed using an oxide semiconductor, oxygen desorption from a channel material of the transistor can be reduced. Consequently, a regular operation period of the transistor can be increased, and a long lifetime of the display apparatus can be implemented.

Further, where the driving transistor is formed with the multi-gate structure wherein two or more transistors are connected in series to each other, oxygen contained in the channel layer of the driving transistor can be prevented from desorbing from the channel.

Consequently, a countermeasure can be taken against a drawback in picture quality which relies upon a characteristic of the driving transistor such as unevenness or roughness.

Furthermore, where the driving transistor is formed with the multi-gate structure, the threshold voltage thereof can be raised in comparison with that where the driving transistor is formed otherwise with the single gate structure and besides it is possible to prevent the voltage which is applied to the light emitting element upon the mobility correction operation from exceeding the threshold voltage of the light emitting element.

Therefore, no countermeasure is required for causing a regular mobility correction operation to be executed, and consequently, reduction in cost can be anticipated.

The above features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a block diagram showing a configuration of a display apparatus to which an embodiment of the present invention is applied;

FIG. 2 is a block circuit diagram showing a pixel circuit of the display apparatus of FIG. 1;

FIGS. 3A and 3B are schematic views illustrating a single gate structure of a related art pixel circuit and a double gate structure of the pixel circuit of FIG. 2, respectively;

FIG. 4 is a timing chart illustrating operation of the pixel circuit of the single gate structure shown in FIG. 3A;

FIG. 5 is a timing chart illustrating operation of the pixel circuit of the double gate structure shown in FIG. 3B;

FIGS. 6A to 6C, 7A to 7C, and 8A to 8C are circuit diagrams of equivalent circuits of the pixel circuits shown in FIGS. 3A and 3B illustrating operation of the circuits and FIGS. 7B and 8B are diagrammatic views illustrating characteristics of the circuits;

FIG. 9A is a block circuit diagram showing a related art pixel circuit and FIG. 9B is a diagram illustrating a time-dependent variation of an I-V characteristic of an EL element of the pixel circuit of FIG. 9A;

FIGS. 10A and 10B are block circuit diagrams showing related art pixel circuits;

FIG. 11 is a graph illustrating a current characteristic of a transistor with respect to the oxygen concentration; and

FIGS. 12A and 12B are a top plan view and a transverse sectional view, respectively, of a transistor of a single gate structure.

### DETAILED DESCRIPTION OF THE PREFERRED EMBODIMENT

In the following, a preferred embodiment of the present invention is described in detail in the following order with reference to the accompanying drawings.

### 1. Configuration of the Display Apparatus and the Pixel Circuit

### 2. Double Gate Structure

### 3. Pixel Circuit Operation for Carrying Out Threshold Value Correction and Mobility Correction

### 1. Configuration of the Display Apparatus and the Pixel Circuit

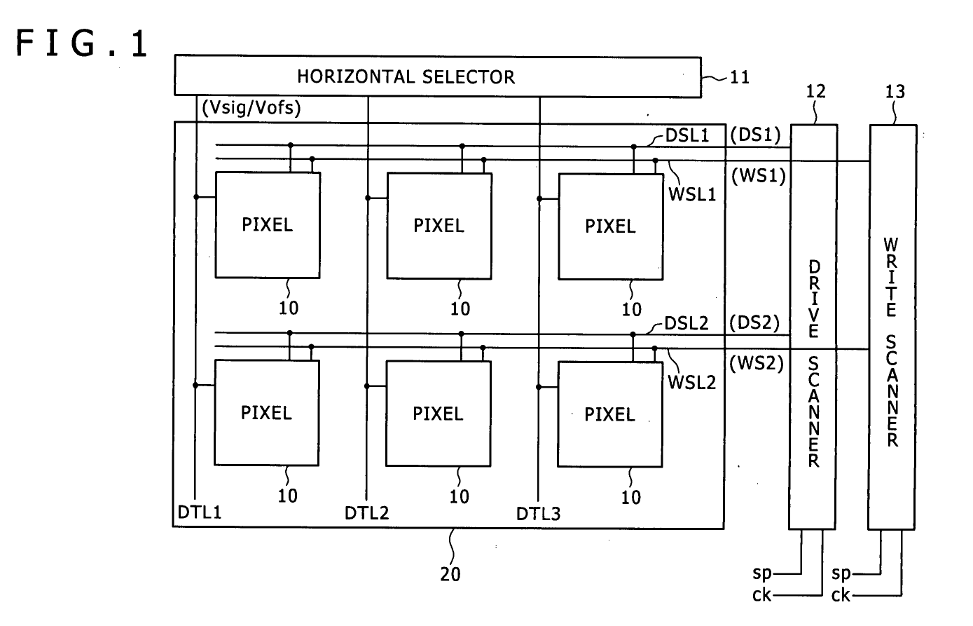

FIG. 1 shows a configuration of an organic EL display apparatus to which the present invention is applied.

Referring to FIG. 1, the organic EL display apparatus shown includes a plurality of pixel circuits 10 which use an organic EL element as a light emitting element thereof and are driven to emit light in accordance with an active matrix method.

In particular, the organic EL display apparatus includes a pixel array 20 including a large number of pixel circuits 10 arrayed in a matrix, that is, in m rows and n columns. It is to be noted that each of the pixel circuits 10 serves as a light emitting pixel for red (R) light, green (G) light or blue (B) light and the pixel circuits 10 of the colors are arrayed in a predetermined rule to form the color display apparatus.

The organic EL display apparatus includes, as components for driving the pixel circuits 10 to emit light, a horizontal selector 11, a drive scanner 12 and a write scanner 13.

Signal lines DTL1, DTL2, . . . for being selected by the horizontal selector 11 to supply a voltage corresponding to a signal value or gradation value of a luminance signal as display data are disposed so as to extend in the direction of a column on the pixel array 20. The number of such signal lines DTL1, DTL2, . . . is equal to the number of columns of the pixel circuits 10 disposed in a matrix on the pixel array 20.

Further, write controlling lines WSL1, WSL2, . . . and power supply controlling lines DSL1, DSL2, . . . are disposed so as to extend in the direction of a row on the pixel array 20. The number of such write controlling lines WSL and power supply controlling lines DSL is equal to the number of rows of the pixel circuits 10 disposed in a matrix on the pixel array 20.

The write controlling lines WSL, that is, WSL1, WSL2, . . . are driven by the write scanner 13. The write scanner 13 successively supplies scanning pulses WS, that is, WS1, WS2, . . . to the write controlling lines WSL1, WSL2, . . . disposed in the direction of a row at predetermined timings to line-sequentially scan the pixel circuits 10 in a unit of a row.

The power supply controlling lines DSL, that is, DSL1, DSL2, . . . , are driven by the drive scanner 12. The drive scanner 12 supplies power supply pulses DS, that is, DS1, DS2, . . . , as power supply voltages, which are changed over between two values of a driving potential Vcc and an initial voltage Vss, to the power supply controlling lines DSL1, DSL2, . . . in a timed relationship with the line-sequential scanning by the write scanner 13.

It is to be noted that the drive scanner 12 and the write scanner 13 set the timing of the scanning pulses WS and the power supply pulses DS based on a clock ck and a start pulse sp.

The horizontal selector 11 supplies a signal value potential Vsig as an input signal to the pixel circuits 10 and a reference value potential Vofs to the signal lines DTL1, DTL2, . . . disposed in the direction of a column in a timed relationship with the line-sequential scanning by the write scanner 13.

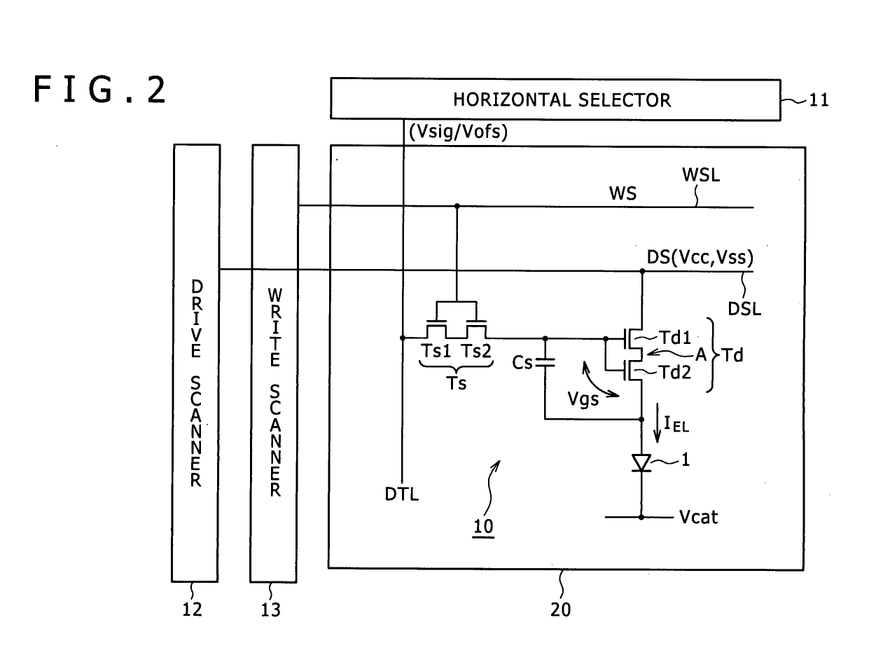

FIG. 2 shows an example of a configuration of a pixel circuit 10. Such pixel circuits 10 are disposed in a matrix like the pixel circuits 10 in the configuration of FIG. 1. It is to be noted that, in FIG. 2, only one pixel circuit 10 disposed at a location at which a signal line DTL crosses with a write controlling line WSL and a power supply controlling line DSL is shown for simplified illustration.

Referring to FIG. 2, the pixel circuit 10 shown includes an organic EL element 1 serving as a light emitting element, a single holding capacitor Cs, and thin film transistors (TFTs) as a sampling transistor Ts and a driving transistor Td.

While the sampling transistor Ts and the driving transistor Td are formed as n-channel TFTs, each of them is formed in a double gate structure of two transistors formed using an oxide semiconductor as a channel material.

As the oxide semiconductor used as the channel material of the transistors, such an oxide as ZnO or IGZO is used.

The driving transistor Td is formed from two transistors Td1 and Td2 made of an oxide semiconductor and connected in series to each other.

Also the sampling transistor Ts is formed from two transistors Ts1 and Ts2 made of an oxide semiconductor and connected in series to each other.

In the following description of the pixel circuit 10 in the embodiment, the term “driving transistor Td” refers to the entire series connection of the transistors Td1 and Td2. Further, in the following description of the pixel circuit 10 in the embodiment, the term “sampling transistor Ts” refers to the entire series connection of the transistors Ts1 and Ts2.

The holding capacitor Cs is connected at one of terminals thereof to the source of the driving transistor Td, that is, to the source on the transistor Td2 side, and at the other terminal thereof to the gate of the driving transistor Td, that is, to the common gate of the transistors Td1 and Td2.

The light emitting element of the pixel circuit 10 is an organic EL element 1 of, for example, a diode structure and has an anode and a cathode. The organic EL element 1 is connected at the anode thereof to the source of the driving transistor Td and at the cathode thereof to a predetermined wiring line, that is, to a cathode potential Vcat.

The sampling transistor Ts (transistors Ts1 and Ts2) is connected at one of the drain and the source thereof to the signal line DTL and at the other one of the drain and the source thereof to the gate of the driving transistor Td. Further, the sampling transistor Ts is connected at the gate thereof, that is, at the common gate of the transistors Ts1 and Ts2, to the write controlling line WSL.

The driving transistor Td is connected at the drain thereof, that is, at the drain on the transistor Td1 side, to the power supply controlling line DSL.

Light emission driving of the organic EL element 1 is carried out basically in the following manner.

At a timing at which a signal value potential Vsig is applied to the signal line DTL, a sampling transistor Ts is rendered conducting by a scanning pulse WS provided thereto from the write scanner 13 through the write controlling line WSL. Consequently, the signal value potential Vsig from the signal line DTL is written into the holding capacitor Cs. The driving transistor Td receives supply of current from the power supply controlling line DSL to which the driving potential Vcc is applied from the drive scanner 12 and supplies current IEL in accordance with the signal potential held in the holding capacitor Cs to the organic EL element 1 to cause the organic EL element 1 to emit light.

In short, while operation that the signal value potential Vsig, that is, a gradation value, is written into the holding capacitor Cs within each frame period, the gate-source voltage Vgs of the driving transistor Td is determined in response to a gradation to be displayed. Since the driving transistor Td operates in its saturation region, it functions as a constant current source to the organic EL element 1 and supplies current IEL in accordance with the gate-source voltage Vgs to the organic EL element 1. Consequently, the organic EL element 1 emits light of the luminance corresponding to the gradation value.

### 2. Double Gate Structure

In the present embodiment, the driving transistor Td and the sampling transistor Ts in the pixel circuit 10 have a double-gate structure formed from a series connection of transistors formed using an oxide semiconductor material as described above.

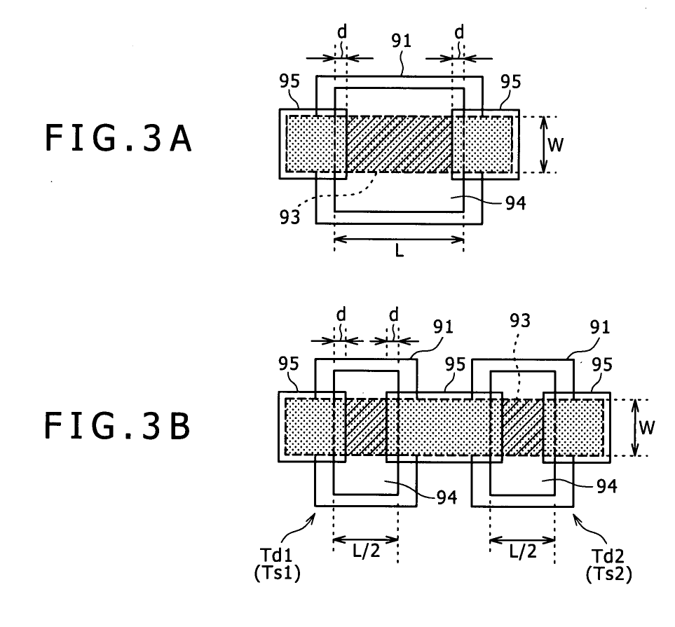

FIGS. 3A and 3B schematically show a single gate structure and a double gate structure, respectively.

In particular, FIG. 3A shows a TFT of a related art single gate structure as viewed from above. Here, the channel width is indicated by W and the channel length is indicated by L.

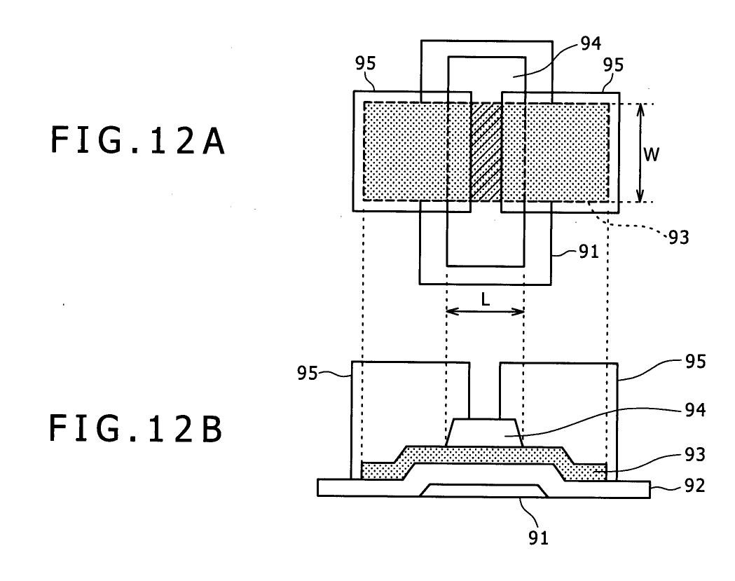

The single gate structure shown in FIG. 3A is similar to that described hereinabove with reference to FIGS. 12A and 12B, and the TFT of the single gate structure shown in FIG. 3A includes gate metal 91, a gate insulating film (not shown: refer to FIG. 12B), a channel material 93, a stopper insulating film 94 and source metal 95.

The area of a region of the single gate structure in which oxygen is estimated to desorb is that of a region in which the stopper insulating film 94 and the channel material 93 overlap with each other and besides the source metal 95 does not overlap with them, that is, a region indicated by slanting lines.

Where the length of the regions in which the source metal 95 overlaps with the stopper insulating film 94 and the channel material 93 is represented by “d,” the area of the regions indicated by slanting lines is given by WL−2dW.

An example of a double gate structure having a transistor size given by the channel width W and the channel length L equal to that of the single gate structure of FIG. 3A is shown in FIG. 3B.

In this instance, the channel width W is equal while the channel length of each transistor is equal to L/2. Also in this instance, the area of a region in which oxygen is estimated to desorb is that of regions in which the stopper insulating film 94 and the channel material 93 overlap with each other and besides the source metal 95 does not overlap with them, that is, regions of the transistors indicated by slanting lines.

The area of the two regions indicated by slanting lines is WL−4dW.

In short, the area of the region in which oxygen is estimated to desorb decreases by 2dW from that of the single gate structure. Therefore, oxygen desorption is decreased.

In other words, where a current supplying capacity is provided by a channel width and a channel length equal to those of the single gate structure, if the double gate structure is used, then the region in which oxygen desorption occurs can be reduced and desorption of oxygen from the channel material can be reduced.

Since oxygen desorption decreases from such a reason as just described, the transistors Td and Ts formed using an oxide semiconductor can carry out normal operation for a longer period of time than a transistor of the single gate structure. Consequently, increase of the lifetime of the display apparatus is implemented.

Further, since, after fabrication, a characteristic of a transistor of the double gate structure does not vary very much through storage in a high temperature condition or the like in comparison with that of a transistor of the single gate transistor, the degree in occurrence of such a drawback in picture quality as unevenness or roughness can be reduced.

It is to be noted that, while, in the present embodiment, both of the sampling transistor Ts and the driving transistor Td have the double gate structure, at least only the driving transistor Td may have the double gate structure.

This is because, while a characteristic dispersion of the driving transistor Td varies depending upon the current flowing to the organic EL element 1 and has a direct connection to inferiority in picture quality such as unevenness or a stripe, the sampling transistor Ts has a lower degree of influence upon the picture quality. In particular, since the sampling transistor Ts is used as a switching element when a signal voltage is inputted to a pixel, even if a current characteristic disperses a little, this does not have an influence on the picture quality if the off leak current is weak to some degree.

### 3. Pixel Circuit Operation for Carrying Out Threshold Value Correction and Mobility Correction

While, in the present embodiment, a transistor of the double gate structure is used as described above, as a further effect provided by this, pixel circuit operation where the driving transistor Td formed using an oxide semiconductor is adopted can be normalized. This is described below.

Since an oxide semiconductor generally has a negative threshold voltage as described hereinabove, in a threshold value correction operation, the source potential of the driving transistor Td has a value higher than the gate potential of the driving transistor Td. Therefore, the voltage applied to the organic EL element 1 in a threshold value correction operation or a mobility correction operation is readily liable to exceed the threshold voltage Vthel of the organic EL element 1, and there is the possibility that the operations may result in failure.

As a countermeasure against this, the cathode potential Vcat may be set to a high level in advance. However, this increases the number of power supplies as much, which gives rise to increase of the cost.

Here, if the driving transistor Td is formed so as to have the double gate structure as in the present embodiment, the threshold voltage Vth can be made higher than that of a transistor of the single gate structure. Consequently, a pixel circuit operation for carrying out threshold value correction and mobility correction can be standardized.

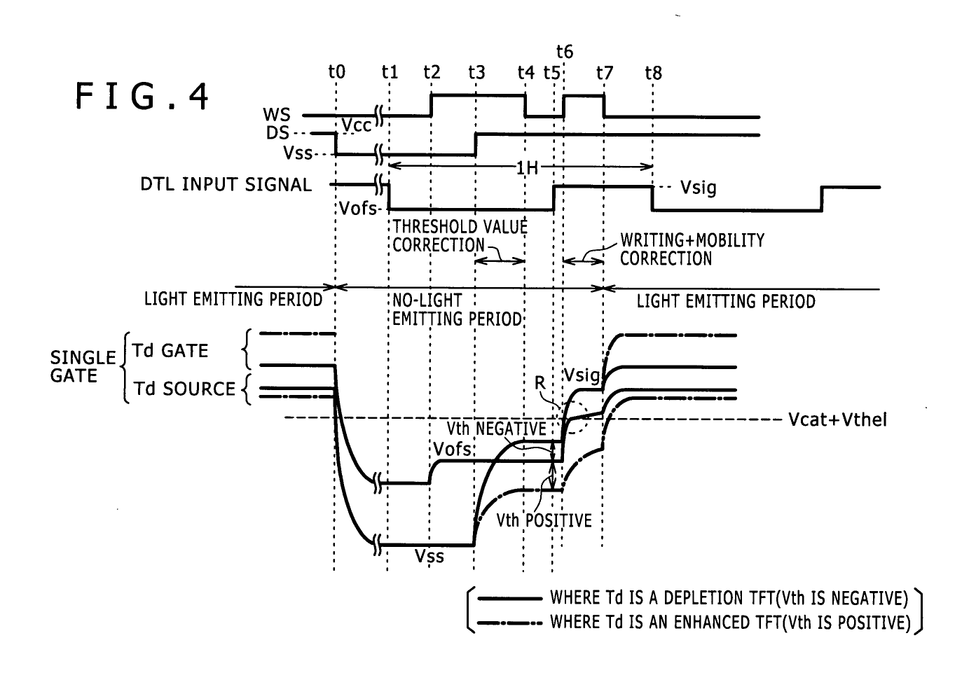

First, a pixel circuit operation is described with reference to FIGS. 4 to 8C.

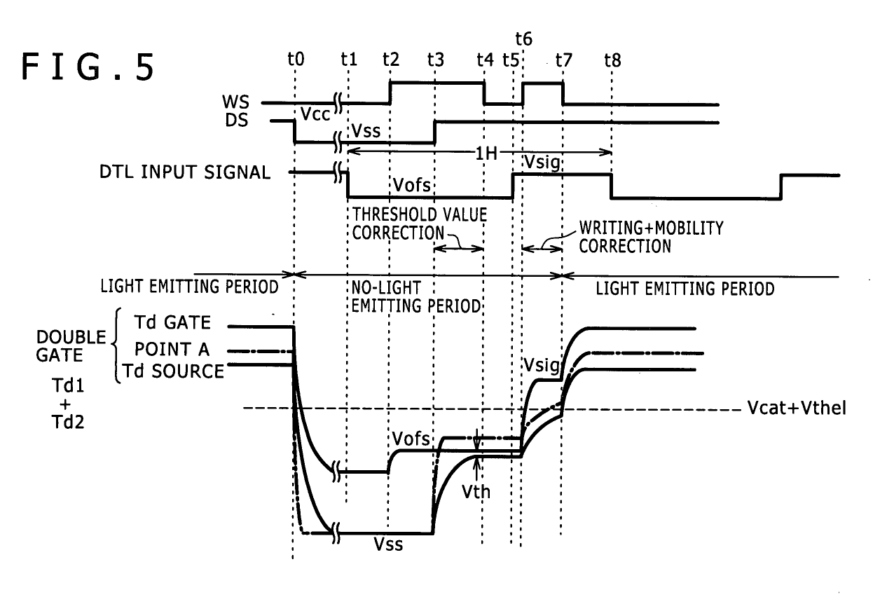

FIG. 4 illustrates operation waveforms of a transistor of the single gate structure, and FIG. 5 illustrates operation waveforms of a transistor of the double gate structure according to the present embodiment.

Referring to FIGS. 4 and 5, a scanning pulse WS applied to the gate of the sampling transistor Ts from the write scanner 13 through the write controlling line WSL and a power supply pulse DS supplied from the drive scanner 12 through the power supply controlling line DSL are illustrated. As the power supply pulse DS, the driving voltage Vcc or the initial voltage Vss is applied.

Meanwhile, as a DTL input signal, a potential provided to the signal line DTL from the horizontal selector 11 is illustrated. The potential is given as the signal value potential Vsig or the reference value potential Vofs.

Further, a variation of the gate voltage and a variation of the source voltage of the driving transistor Td are illustrated as a waveform denoted by Td gate and a waveform denoted by Td source, respectively.

In FIG. 4, a solid line curve of each of the Td gate waveform and the Td source waveform is a variation where a depletion TFT is used for the driving transistor Td while an alternate long and short dash line indicates a variation where an enhanced TFT is used for the driving transistor Td.

The enhanced TFT is used generally in the organic EL element 1. The threshold voltage Vth of the enhanced TFT has a positive value. On the other hand, a transistor of an oxide semiconductor is a depletion TFT, and the threshold voltage Vth of the same has a negative value.

Meanwhile, in FIG. 5, a variation of the gate voltage and a variation of the source voltage of the driving transistor Td (Td1+Td2) of the double gate structure formed using an oxide semiconductor are illustrated as a waveform denoted by Td gate and a waveform denoted by Td source, respectively. A point A in FIG. 5 is a node between the transistors Td1 and Td2 shown In FIG. 2, and a potential variation at the point A is indicated by an alternate long and short dash line.

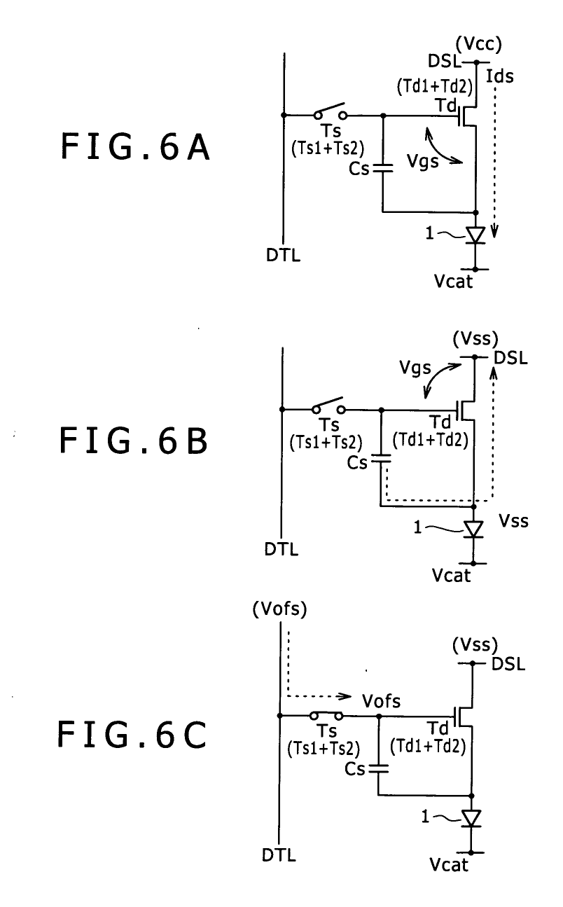

Equivalent circuits shown in FIGS. 6A to 8C illustrate the process of operation in FIG. 4 or 5.

It is to be noted that the equivalent circuits in FIGS. 6A to 8C are shown as equivalent circuits common to the single gate structure and the double gate structure. Accordingly, it should be recognized that the driving transistor Td shown in the equivalent circuits represents a single transistor where the transistor has the single gate structure but represents a series connection of the two transistors Td1 and Td2 where the transistor has the double gate structure in the present embodiment. This similarly applies also to the sampling transistor Ts.

Since basic pixel circuit operation is the same between the single gate structure and the double gate structure, the pixel circuit operation is described below with reference to the waveform diagram of FIG. 5 and the equivalent circuit diagrams and characteristic diagrams of FIGS. 6A to 8C.

First, as the gate voltage and the source voltage, those of a related art enhanced TFT indicated by alternate long and short dash lines in FIG. 4 should be referred to.

Till time t0 in FIG. 4, light emission in a preceding frame is carried out. The equivalent circuit in this light emitting state is such as shown in FIG. 6A. In particular, the driving voltage Vcc is supplied to the power supply controlling line DSL. The sampling transistor Ts is in an off state. At this time, since the driving transistor Td is set so as to operate in the saturation region thereof, the current Ids flowing to the organic EL element 1 assumes a value indicated by the expression (1) given hereinabove in accordance with the gate-source voltage Vgs of the driving transistor Td.

After time t0 of FIG. 4, operation for one cycle for light emission in a present frame is carried out. This one cycle is a period up to a timing corresponding to time t0 in a next frame.

At time t0, the drive scanner 12 sets the power supply controlling line DSL to the initial voltage Vss.

The initial voltage Vss is set lower than the sum of the threshold voltage Vthel and the cathode potential Vcat of the organic EL element 1. In short, the initial voltage Vss is set so as to satisfy Vss<Vthel+Vcat. Consequently, the organic EL element 1 emits no light, and the power supply controlling line DSL serves as the source of the driving transistor Td as seen in FIG. 6B. At this time, the anode of the organic EL element 1 is charged up to the initial voltage Vss. In other words, in FIG. 4, the source voltage of the driving transistor Td drops down to the initial voltage Vss.

At time t1, the signal line DTL is set to the potential of the reference value potential Vofs by the horizontal selector 11. Thereafter, at time t2, the sampling transistor Ts is turned on in response to the scanning pulse WS. Consequently, the gate potential of the driving transistor Td is made equal to the potential of the reference value potential Vofs as seen in FIG. 6C.

At this time, the gate-source voltage of the driving transistor Td has the value of Vofs−Vss. Here, to set the gate potential and the source potential of the driving transistor Td sufficiently higher than the threshold voltage Vth of the driving transistor Td makes preparations for a threshold value correction operation. Accordingly, it is necessary for the reference value potential Vofs and the initial voltage Vss to be set so as to satisfy Vofs−Vss>Vth.

The threshold value correction operation is carried out within a period from time t3 to time t4.

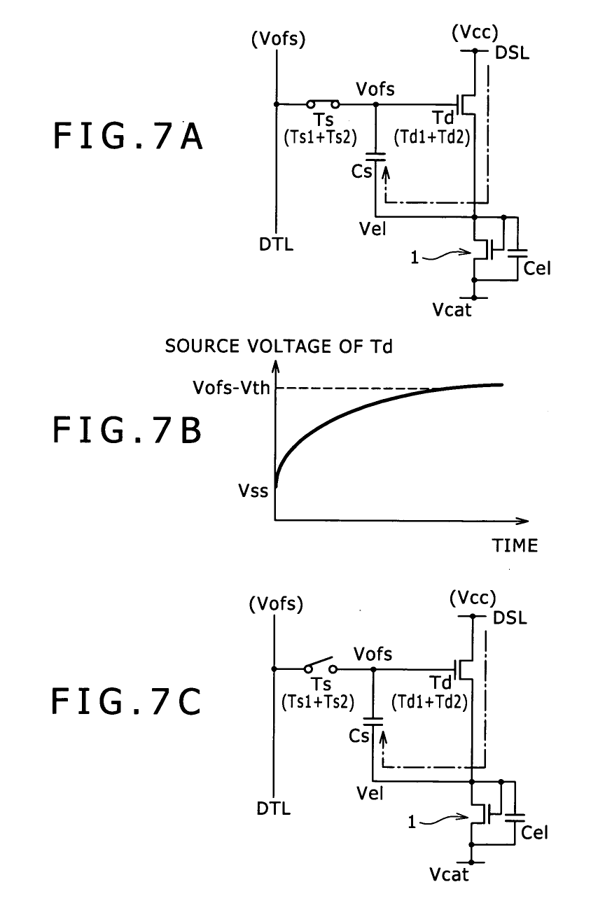

In this instance, the power supply pulse DS of the power supply controlling line DSL is set to the driving voltage Vcc. Consequently, the anode of the organic EL element 1 serves as the source of the driving transistor Td, and current flows as seen in FIG. 7A.

The equivalent circuit of the organic EL element 1 is represented by a diode and a capacitor Cel as seen in FIG. 7A. Therefore, the current of the driving transistor Td is used to charge up the holding capacitor Cs and the capacitor Cel as long as the anode potential Vel of the organic EL element 1 satisfies Vel≦Vcat+Vthel, that is, the leak current of the organic EL element 1 is considerably smaller than the current flowing to the driving transistor Td.

At this time, the anode potential Vel, that is, the source potential of the driving transistor Td, rises as time passes as seen in FIG. 7B. After lapse of a fixed period of time, the gate-source voltage of the driving transistor Td assumes the value of the threshold voltage Vth. Where the driving transistor Td is an enhanced TFT, the gate-source voltage assumes a value denoted by “Vth positive” in FIG. 4.

At this time, Vel=Vofs−Vth Vcat+Vthel is satisfied. Thereafter, at time t4, the scanning pulse WS falls and the sampling transistor Ts is turned off to complete the threshold value correction operation as seen in FIG. 7C.

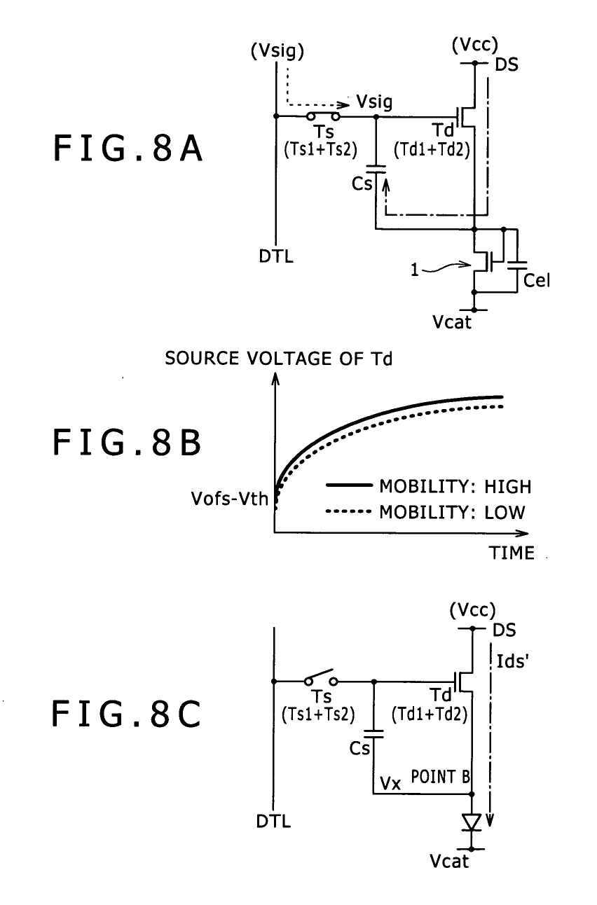

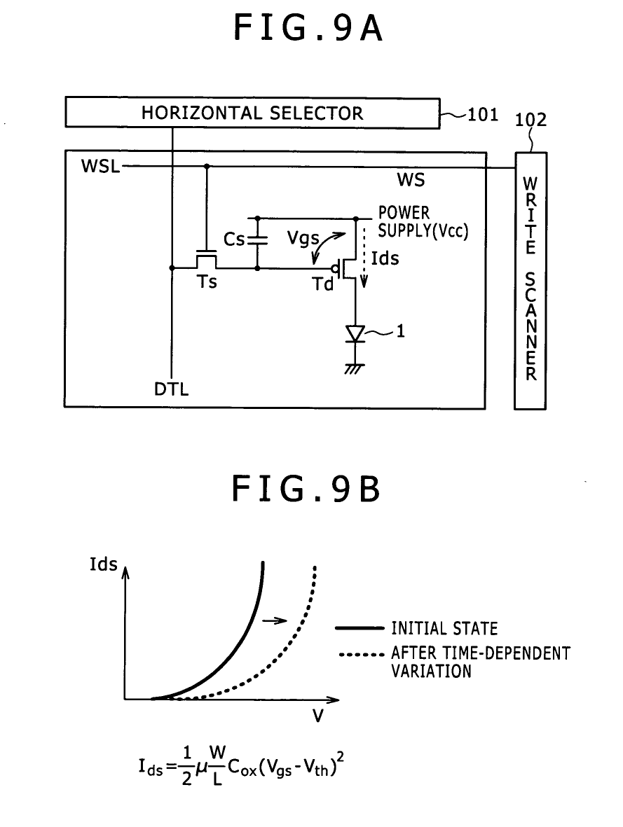

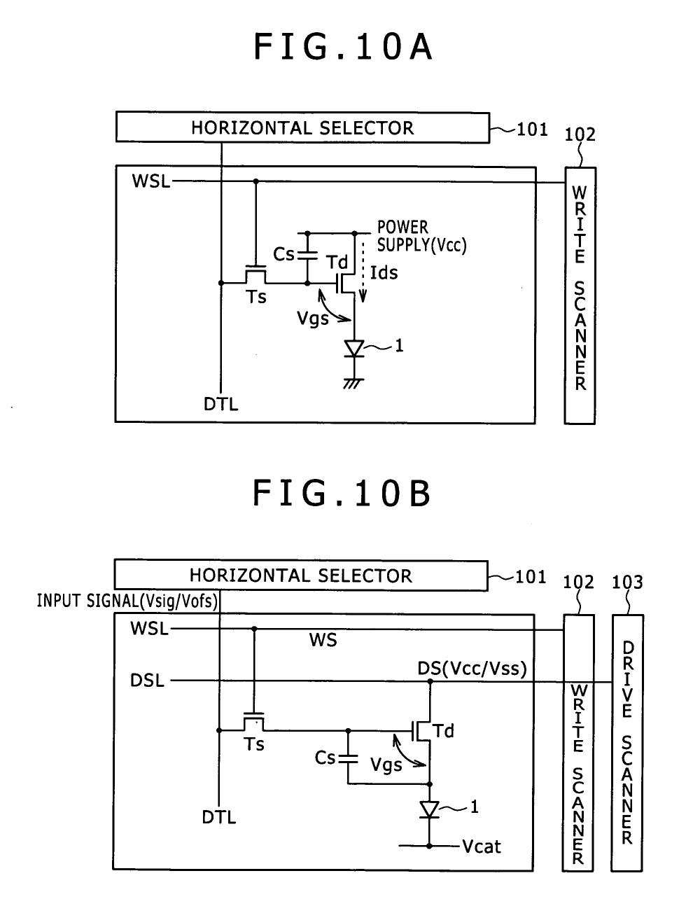

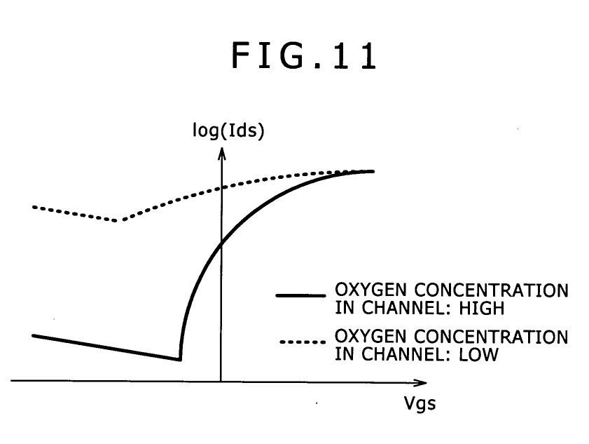

Then at time t5, the signal line potential becomes the potential Vsig, and then at time t6, the scanning pulse WS rises and the sampling transistor Ts is turned on so that the signal value potential Vsig is inputted to the gate of the driving transistor Td as seen in FIG. 8A.

The signal value potential Vsig indicates a voltage corresponding to a gradation. Since the sampling transistor Ts is on, the gate potential of the driving transistor Td becomes the potential of the signal value potential Vsig. However, since the power supply controlling line DSL indicates the driving voltage Vcc, current flows, and the source potential of the sampling transistor Ts rises as time passes.

At this time, if the source voltage of the driving transistor Td does not exceed the sum of the threshold voltage Vthel and the cathode potential Vcat of the organic EL element 1, that is, if the leak current of the organic EL element 1 is considerably smaller than the current flowing to the driving transistor Td, then the current of the driving transistor Td is used to charge up the holding capacitor Cs and the capacitor Cel.

Then at this time, since the threshold value correction operation of the driving transistor Td has been completed, the current supplied from the driving transistor Td represents the mobility p.

In particular, where the mobility is high, the amount of current at this time is great, and also the speed of the rise of the source potential is high. On the contrary, where the mobility is low, the amount of current at this time is small, and also the speed of the rise of the source potential is low. FIG. 8B indicates rises of the source voltage where the mobility is high and low.

Consequently, the gate-source voltage of the driving transistor Td decreases reflecting the mobility, and after lapse of a fixed period of time, it becomes equal to the gate-source voltage Vgs with which the mobility is corrected fully.

In this manner, within the period from time t6 to time t7, writing of the signal value potential Vsig into the holding capacitor Cs and mobility correction are carried out.

Then at time t7, the scanning pulse WS falls and the sampling transistor Ts is turned off to end the signal value writing, and the organic EL element 1 emits light.

Since the gate-source voltage Vgs of the driving transistor Td is fixed, the driving transistor Td supplies fixed current Ids′ to the organic EL element 1 as seen in FIG. 8C. The anode potential Vel at a point B, that is, the anode potential of the organic EL element 1, rises to a voltage Vx with which the fixed current Ids′ flows to the organic EL element 1, and the organic EL element 1 emits light.

Thereafter, the emission of light is continued till a next light emission cycle, that is, till time t0 of the next frame. It is to be noted that the signal line DTL is set to the reference value potential Vofs at time t8. This is because the signal line DTL is ready for operation of a pixel circuit in a next horizontal line for a period later than time t1 in FIG. 4.

It is to be noted that, in such operation as described above, if a long period of light emitting time of the organic EL element 1 passes, then the I-V characteristic of the organic EL element 1 varies. Therefore, also the potential at the point B in FIG. 8C varies. However, since the gate-source voltage Vgs of the driving transistor Td is kept at a fixed value, the current to flow to the organic EL element 1 does not vary. Therefore, even if the I-V characteristic of the organic EL element 1 degrades, the fixed current always continues to flow and the luminance of the EL element does not vary.

In the operation described above, where the driving transistor Td is an enhanced TFT, the gate potential and the source potential of the same vary as indicated by alternate long and short dash lines in FIG. 4, and normal operation is carried out.

However, where a depletion TFT fabricated using an oxide semiconductor is adopted for the driving transistor Td, the gate potential and the source potential of the same vary as indicated by solid lines in FIG. 4.

In particular, since the driving transistor Td as a depletion TFT has a negative threshold voltage, in the threshold value correction operation, the source potential of the driving transistor Td exhibits a value higher than that of the gate potential of the driving transistor Td as indicated by “Vth negative” in FIG. 4.

However, even if a negative threshold value is held between the gate and the source, this fact itself does not matter. This is because the threshold value correction operation sets, before writing of the signal value potential Vsig, the gate-source voltage equal to the threshold voltage to cancel a dispersion of the threshold value of the driving transistor Td among the pixels. In other words, this is because the threshold value correction operation is to set the gate-source voltage of the driving transistor Td to a value corresponding to the signal value potential Vsig with reference to the threshold value unique to each driving transistor Td thereby to supply current corresponding to the signal value potential Vsig, that is, to the gate-source voltage Vgs, to the organic EL element 1.

What matters is that, where the source potential is higher than the gate voltage, upon later mobility correction, current becomes more likely to flow to the organic EL element 1 and cause the organic EL element 1 to emit light.

The mobility correction is carried out regularly where current supplied from the driving transistor Td to which the driving voltage Vcc is applied is used to charge up the holding capacitor Cs and the capacitor Cel without flowing to the organic EL element 1.

However, by a potential rise thereupon, the source potential is likely to exceed the threshold value (Vthel+Vcat) of the organic EL element 1 as indicated by a portion of a curve in a broken line circle R of FIG. 4. Consequently, at this point of time, current flows to the organic EL element 1 to cause the organic EL element 1 to emit light, and the mobility correction operation fails to operate regularly.

In order to cope with this, it is necessary to take such a countermeasure as to raise the cathode potential Vcat in advance. However, this gives rise to increase of the cost by increase of the number of power supplies.

In contrast, the operation of the driving transistor Td having the double gate structure in the present embodiment is carried out regularly as seen in FIG. 5. It is to be noted that a basic light emission operation in one cycle is similar to that described hereinabove.

Here, the potential variations indicated by solid lines as the gate voltage and the source voltage are those as viewed in the entire driving transistor Td (=Td1+Td2) of the double gate structure.

An alternate long and short dash line in FIG. 5 indicates the potential at the point A shown in FIG. 2, that is, at a node between the transistors Td1 and Td2.

In this instance, since the driving transistor Td has the double gate structure, in the threshold value correction operation within the period from time t3 to time t4, the potential at the point A rises earlier than the anode potential of the organic EL element 1. This is because the transistor Td2 side is connected to the capacitors Cs and Cel. Therefore, the threshold value correction on the transistor Td1 side is carried out first as seen from the alternate long and short dash line curve.

Then, the anode potential of the organic EL element 1 rises with respect to the potential at the point A. At this time, it is absolutely impossible from the potential relationship that the anode potential of the organic EL element 1, that is, the source potential as viewed from the entire driving transistor Td, becomes higher than the potential at the point A.

Therefore, even if the threshold voltage of the individual transistors Td1 and Td2 has a negative value, the threshold voltage of the entire driving transistor Td is a higher threshold voltage. For example, the threshold voltage of the entire driving transistor Td becomes a positive threshold voltage Vth as seen in FIG. 5. Since the gate potential is fixed to the reference value potential Vofs, the source potential after the threshold value correction operation can be made low from the fact that the threshold voltage is high.

In short, the anode potential of the organic EL element 1 at a point of the end of the threshold value correction operation can be made lower than that where the single gate structure is adopted.

Consequently, upon signal value writing and mobility correction within the succeeding period from time t6 to time t7, the source potential, that is, the anode potential of the organic EL element 1, can be prevented from exceeding the threshold value (Vthel+Vcat) of the organic EL element 1. Then, since no current flows to the organic EL element 1, the mobility correction operation is carried out regularly.

From the foregoing, also where a transistor formed using an oxide semiconductor is used, such a countermeasure as to raise the cathode potential Vcat in advance in order to standardize the circuit operation is not required, and consequently, reduction of the cost can be implemented.

It is to be noted here that the cathode potential Vcat is preferably set equal to the ground.

Further, if the channel length L of the transistor Td1 which is positioned nearer to the driving voltage Vcc of the power supply from between the transistors Td1 and Td2 of the driving transistor Td is set greater, then an effect that the threshold voltage Vth can be further raised can be obtained. This arises from the fact that, as the channel length L increases, the threshold voltage of the transistor Td1 itself becomes comparatively great.

As described above, in the present embodiment, where an oxide semiconductor is used to fabricate the driving transistor Td and the sampling transistor Ts in the pixel circuit 10, oxygen desorption can be reduced to implement improvement of the lifetime by forming the driving transistor Td and the sampling transistor Ts so as to have the double-gate structure.

It is to be noted that, although various configurations which include three or more transistors are available as configurations for a pixel circuit, where a transistor which is formed using an oxide semiconductor as a channel material thereof is used, it is particularly preferable to form all transistors in the pixel circuit so as to have the double gate structure in order to achieve improvement of the lifetime of the display apparatus.

Further, by forming at least the driving transistor Td so as to have the double gate structure, a countermeasure can be taken against a drawback in picture quality which relies upon a characteristic of the driving transistor Td such as unevenness or roughness.

Furthermore, by forming the driving transistor Td so as to have the double gate structure, the threshold voltage can be made high in comparison with that of a transistor of the single gate, and it is possible to prevent the voltage to be applied to the organic EL element 1 in the threshold value correction operation and the mobility correction operation from exceeding the threshold voltage. Therefore, a regular threshold value correction operation and a regular mobility correction operation are executed, and there is no necessity to take a countermeasure for assuring regular operation. Consequently, reduction in cost can be implemented.

It is to be noted that, while the present invention is described above in connection with the embodiment thereof wherein a transistor has the double gate structure, the present invention can be applied also to a structure wherein, for example, three or more transistors formed using an oxide semiconductor are connected in series.

Further, while the driving transistor Td described above has a negative threshold voltage, the present invention can be applied also to a transistor having a positive threshold voltage.

The present application contains subject matter related to that disclosed in Japanese Priority Patent Application JP 2009-115193 filed in the Japan Patent Office on May 12, 2009, the entire content of which is hereby incorporated by reference.

While a preferred embodiment of the present invention has been described using specific terms, such description is for illustrative purposes only, and it is to be understood that changes and variations may be made without departing from the spirit or scope of the following claims.

What is claimed is:

1. A display apparatus, comprising:
a pixel array including a plurality of pixel circuits disposed in a matrix and each including a light emitting element, a driving transistor for supplying current in response to a signal value applied between a gate and a source thereof to said light emitting element when a driving voltage is applied between a drain and the source thereof, and a holding capacitor connected between the gate and the source of said driving transistor for holding the input signal value, said driving transistor having a multi-gate structure wherein two or more transistors formed using an oxide semiconductor material are connected in series; and
a light emission driving section configured to apply the signal value to said holding capacitor of each of said pixel circuits of said pixel array so that the light emitting element of the pixel circuit emits light of a gradation corresponding to the signal value.

2. The display apparatus according to claim 1, wherein
each of said pixel circuits includes a sampling transistor for applying the signal value supplied from said light emission driving section to said holding capacitor, also said sampling transistor having a multi-gate structure wherein two or more transistors formed using an oxide semiconductor material are connected in series.

3. The display apparatus according to claim 2, wherein said light emission driving section includes:
a signal selector for supplying a potential as the signal value and a reference value to each of signal lines disposed so as to extend in the direction of a column on said pixel array;
a write scanner for driving each of writing control lines disposed so as to extend in the direction of a row on said pixel array to introduce the potential of the corresponding signal line into the pixel circuits; and
a driving control scanner for applying a driving voltage to said driving transistor of the pixel circuits using each of power supply control lines disposed so as to extend in a row on said pixel array;
said sampling transistor being connected at a gate thereof to the writing control line, at one of a source and a drain thereof to the signal line and at the other of the source and the drain thereof to the gate of said driving transistor.

4. The display apparatus according to claim 3, wherein each of said pixel circuits carries out, as a light emission operation of one cycle:
a threshold value correction operation of said driving transistor of the multi-gate structure by rendering said sampling transistor conducting under the control of said write scanner, within a period within which the potential as the reference value is applied to said signal line by said signal selector, to fix the gate potential of said driving transistor to the reference value and applying, in this state, the driving voltage to said driving transistor from said driving control scanner;
writing of the signal value into said holding capacitor and a mobility correction operation of said driving transistor of the multi-gate structure within another period within which the potential as the signal value is applied to the signal line from said selector by rendering said sampling transistor under the control of said write scanner; and
emission of light from said light emitting element with a luminance in accordance with the signal value by supplying, after the writing of the signal value and the mobility correction, the current in accordance with the signal value written in said holding capacitor from said driving transistor to said light emitting element.

5. The display apparatus according to claim 1, wherein
said light emitting element is an organic electroluminescence light emitting element.

6. A display apparatus, comprising:
a pixel array including a plurality of pixel circuits disposed in a matrix and each including an organic electroluminescence light emitting element, a plurality of transistors including a driving transistor for supplying current in accordance with a signal value provided between a gate and a source thereof to said organic electroluminescence light emitting element when a driving voltage is applied between a drain and the source thereof, and a holding capacitor connected between the gate and the source of said driving transistor for holding the signal value inputted thereto, all of the plural transistors having a multi-gate structure wherein two or more transistors formed using an oxide semiconductor material are connected in series to each other; and
a light emission driving section configured to apply the signal value to said holding capacitor of each of said pixel circuits of said pixel array so that the light emitting element of the pixel circuit emits light of a gradation corresponding to the signal value.
